(19) United States
(12) Patent Application Publication
(10) Pub. No.: US 2025/0314151 A1
(43) Pub. Date: Oct. 9, 2025

(54) CHECK VALVE FOR DOWNHOLE GAS LINES

(71) Applicant: Liberty Lift Solutions, LLC, Houston, TX (US)

(72) Inventors: Michael S. Juenke, Point Blank, TX (US); Zlatko Salihbegovic, Gulf Breeze, FL (US); Roddie R. Smith, Katy, TX (US); Rick Daniel Haydel, Youngsville, LA (US)

(73) Assignee: Liberty Lift Solutions, LLC, Houston, TX (US)

(21) Appl. No.: 19/090,584

(22) Filed: Mar. 26, 2025

Related U.S. Application Data
(60) Provisional application No. 63/573,817, filed on Apr. 3, 2024.

(51) Int. Cl. E21B 34/08; F16K 15/02

(52) U.S. Cl. CPC E21B 34/08; F16K 15/026

(57) ABSTRACT

A downhole check valve for controlling flow of gas through a flowline of a gas lift system, that includes a valve housing formed from an inlet sub-housing and a dart sub-housing where a resilient valve seat is held between an end surface of the inlet sub-housing and another surface and where, when check valve dart element is in its open position, the smallest cross-sectional diameter of the valve seat opening is less than the smallest cross sectional diameter of the inlet sub-housing.

### CROSS REFERENCE TO RELATED APPLICATIONS

This application claims priority to U.S. Provisional Patent Application No. 63/573,817 filed on Apr. 3, 2024 and entitled “Check Valve for Downhole Gas Lines.”

### FIELD OF THE INVENTION

The present invention relates generally to check valves for downhole gas lines used in gas lift systems.

### BACKGROUND OF THE INVENTION

In many oil wells the formation pressure of the well, at least initially, will be sufficiently high to push liquid hydrocarbons, that is, oil all the way to the surface. Over time as production continues, however, the hydrostatic pressure urging fluids upward is no longer sufficiently high to push oil all the way to the surface. At that point, a well operator may rely on gas lift systems to assist in lifting oil out of the well.

Gas lift systems—in one fashion or another—use natural gas to assist in moving oil to the surface. Different gas lift techniques, such as continuous gas lift, intermittent gas lift, plunger-assisted lift, and gas pumps, may be employed over the life of a well as production is depleted. Many of those systems rely on flow lines to convey the gas downhole where it will be injected into the liquid production stream. Since well pressure can vary significantly, many systems will include check valves in the gas flow lines to ensure that gas only flows in the desired direction.

Such check valves commonly include a spring-loaded dart that is biased by the spring onto a valve seat. The dart can be lifted off the valve seat as fluid and/or gas flows through the valve in the desired flow direction. Should an unexpected rise in downhole pressure occur, gas and other fluids might otherwise enter the flow line and flow in the reverse direction through the valve. Because the dart is biased onto the seat, however, if fluid begins to flow in the reverse direction through the valve, the valve will tend to automatically close. One limitation on many conventional check valves is that, when the dart is lifted off the valve seat (and in an open position such that gas and/or fluid can flow through the valve) the valve may be subjected to fluctuations with respect to aspects of the flow (e.g., pressure, particulate content, gas/liquid ration, etc.) that will tend to cause the dart to move towards or to a closed position where it is temporarily seated on the valve seat before moving again towards and to an open position. These movements between or within an open position and a closed position (sometimes referred to as “chatter”) are undesirable for a variety of reasons, including that they tend to restrict desired flow through the valve.

A further limitation of many conventional check valves is that they do not always operate properly under certain well conditions. In certain types of wells, for example, wells subject to fracking operations, a high degree of particulates (e.g., frac sand, proppants, etc.) can be found in the well fluids. When conventional checks valves are in an open position in such wells, the fluid particulates can accumulate at various locations in the check valve. Such accumulated particulate can both degrade the check valve operation (e.g., by preventing a valve from moving to a fully open or fully closed position) and/or cause the valve to fail (e.g., by getting stuck in a closed, open, or intermediate position).

A still further limitation of many conventional check valves is that they commonly include components that are subject to undesired abrasion and wear as particulates move through the valve. Such abrasion can result in both undesired failure of such check valves and/or undesired rapid wear of the valves, such that field maintenance or replacement is required to prevent an undesired failure of the valve. Such wear can be particularly pronounced with respect to the valve seat, which is often formed from a resilient material that is more subject to wear than other components of the check valve.

It is an objective of the present disclosure to overcome these, and other, limitations of known downhole check valves.

The statements in this section are intended to provide background information related to the invention disclosed and claimed herein. Such information may or may not constitute prior art. It will be appreciated from the foregoing, however, that there remains a need for new and improved check valves for downhole gas lines. For example, there is a continuing need for check valves that have reduced risk of failure, and that have increased service life. Such disadvantages and others inherent in the prior art are addressed by various aspects and embodiments of the subject invention.

Additionally, it is to be understood that the discussion above is provided for illustrative purposes only and is not intended to and does not limit the scope or subject matter of the appended or ultimately issued claims or those of any related patent application or patent. Thus, none of the appended claims, ultimately issued claims or claims of any related application or patent are to be limited by the above discussion or construed to address, include, or exclude each or any of the above-cited features or disadvantages merely because such were mentioned herein.

### BRIEF SUMMARY OF THE INVENTION

A brief non-limiting summary of one of the many possible embodiments of the inventions disclosed herein is a downhole check valve for controlling flow of gas through a flowline of a gas lift system, the downhole check valve comprising: a valve housing having an inlet, an outlet, and an internal flow path extending from the inlet to the outlet, the valve housing comprising: a dart sub, the dart sub having a bore passing axially therethrough; an inlet sub coupled the dart sub, the inlet sub having a bore passing axially therethrough and an end surface, the inlet sub bore having at least one cross-sectional diameter; a valve seat located within the valve housing, the valve seat being formed from a resilient material and held between the first end surface of the inlet sub and another surface, the valve seat defining a valve seat expanding opening including a section having an internal cross-sectional diameter that increases axially from a first point along the axis of the valve housing to a second point along the valve housing axis, wherein the first point is closer to the inlet than is the second point; a dart located within valve housing, the dart including: a dart seating surface, the dart seating surface including a section having a cross-section that increases axially from a third point along the axis of the valve housing to a fourth point, wherein the third point is closer to the inlet than is the fourth point; wherein, the dart is movable between an open position permitting fluid flow through the valve housing and a closed position blocking fluid flow through the valve, and wherein, when the dart is in its open position, the smallest cross-sectional diameter of the valve seat expanding opening is less than the smallest cross sectional diameter of the inlet sub.

Additionally or alternately an embodiment may take the form of a downhole check valve for controlling flow of gas through a flowline of a gas lift system, the downhole check valve comprising: a valve housing having an inlet, an outlet, and an internal fluid flow path extending from the inlet to the outlet, the valve housing comprising an inlet housing, the inlet housing defining a first opening comprising the valve housing inlet and second opening, the second opening being located at an end of the inlet housing opposite the first opening; a valve seat located within the valve housing, the valve seat being formed from a resilient material, the valve seat defining a valve seat expanding opening including a section having a cross-sectional diameter that increases axially from a first point along the axis of the valve housing to a second point along the valve housing axis, wherein the first point is closer to the inlet than is the second point; a dart located within valve housing, the dart including: a dart seating surface having a cross-section that increases axially from a third point along the axis of the valve housing to a fourth point, wherein the third point is closer to the inlet than is the fourth point; an internal cylindrical cavity having a closed end, a closed end surface, an open end, and an open end ledge surface; a valve stem member at least partially positioned within the second housing, the valve stem member including a post that extends into the dart internal cylindrical cavity, the valve stem member further including a ledge surface, and a resilient member positioned entirely within the dart internal a cylindrical cavity and between the dart closed end surface and a surface of the post;
wherein, when the downhole check valve is in its open position, the smallest cross-sectional diameter of the valve seat opening is less than the cross sectional diameter of the inlet housing second opening and the dart open end ledge surface at least substantially abuts the ledge surface of the valve stem member.

None of these brief summaries of the inventions is intended to limit or otherwise affect the scope of what has been disclosed and enabled or the appended claims, and nothing stated in this Brief Summary of the Invention is intended as a definition of a claim term or phrase or as a disavowal or disclaimer of claim scope.

### BRIEF DESCRIPTION OF THE DRAWINGS

The following figures form part of the disclosure of inventions and are included to demonstrate further certain aspects of the inventions. The inventions may be better understood by reference to one or more of these figures in combination with the detailed description of certain embodiments presented herein.

FIG. 1A is a longitudinal cross-sectional view of a first preferred embodiment 20 of the novel downhole check valves of the subject invention which may be used in a downhole gas line to allow flow in a desired flow direction and to check flow in the reverse flow direction, novel check valve 20 being shown in its closed state.

FIG. 1B is a longitudinal cross-sectional view of check valve 20 showing valve 20 in its open state.

FIG. 2 is a close-up view taken in the area of valve seat 24, wear sleeve 25, and the leading end of dart 27 shown in FIGS. 1.

FIG. 3 depicts an alternate embodiment of the example of FIGS. 1A and 1B in which the valve stem 26 is integrally formed with a section of the valve housing (namely sub-housing 23c in the illustrated example).

FIG. 4 depicts an alternate embodiment of the example of FIGS. 1A and 1B in which the valve stem 26 is formed separately from the valve housing elements and in which the valve housing is formed from two sub-housings (namely sub-housings 23a and 232 in the illustrated example).

FIG. 5 depicts an alternate embodiment of the example of FIGS. 1A and 1B in which the valve stem 26 is integrally formed with a section of the valve housing (namely sub-housing 230 in the illustrated example), a valve seat 24 is positioned between surface of a ring element and one of the sub-housings (namely sub-housing 23a in the example), and the flow path of fluid through the valve is defined, at least in part, by an interior surface profile of one of the sub-housings (namely sub-housing 236 in the example).

FIG. 6 depicts an alternate embodiment of the example of FIGS. 1A and 1B in which a valve seat 24 is positioned between surfaces of two of the sub-housings (namely sub-housings 23a and 23b in the example), the flow path of fluid through the valve is defined, at least in part, by an interior surface profile of one of the sub-housings (namely sub-housing 23b in the example), and a dart 600 having an extending post about which is placed a spring element is utilized.

In the drawings and description that follows, like parts are identified by the same reference numerals. The drawing figures are not necessarily to scale. Certain features of the embodiments may be shown in exaggerated scale or in somewhat schematic form and some details of conventional design and construction may not be shown in the interest of clarity and conciseness.

While the inventions disclosed herein are susceptible to various modifications and alternative forms, only a few specific embodiments have been shown by way of example in the drawings and are described in more detail below. The figures and detailed descriptions of these embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts illustrated and taught by the specific embodiments.

### DESCRIPTION OF ILLUSTRATIVE EMBODIMENTS

The Figures described above, and the written description of specific structures and functions below, are not presented to limit the scope of the inventions disclosed or the scope of the appended claims. Rather, the Figures and written description are provided to teach a person skilled in this art to make and use the inventions for which patent protection is sought.

A person of skill in this art having benefit of this disclosure will understand that the inventions are disclosed and taught herein by reference to specific embodiments, and that these specific embodiments are susceptible to numerous and various modifications and alternative forms without departing from the inventions we possess. For example, and not limitation, a person of skill in this art having benefit of this disclosure will understand that Figures and/or embodiments that use one or more common structures or elements, such as a structure or an element identified by a common reference number, are linked together for all purposes of supporting and enabling our inventions, and that such individual Figures or embodiments are not disparate disclosures. A person of skill in this art having benefit of this disclosure immediately will recognize and understand the various other embodiments of our inventions having one or more of the structures or elements illustrated and/or described in the various linked embodiments. In other words, not all possible embodiments of our inventions are described or illustrated in this application, and one or more of the claims to our inventions may not be directed to a specific, disclosed example. Nonetheless, a person of skill in this art having benefit of this disclosure will understand that the claims are fully supported by the entirety of this disclosure.

Those persons skilled in this art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

Further, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the scope of what is claimed.

Reference throughout this disclosure to “one embodiment,” “an embodiment,” or similar language means that a particular feature, structure, or characteristic described in connection with the embodiment is included in at least one of the many possible embodiments of the present inventions. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The description of elements in each Figure may refer to elements of proceeding Figures. Like numbers refer to like elements in all figures, including alternate embodiments of like elements. In some possible embodiments, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

The subject invention relates generally to downhole gas check valves for gas lift systems for enhancing the flow of oil and other liquids from wells. Some of the embodiments are described in detail herein. For the sake of conciseness, however, all features of an actual implementation may not be described or illustrated. In developing any actual implementation, as in any engineering or design project, numerous implementation-specific decisions must be made to achieve a developers' specific goals. Decisions usually will be made consistent within system-related and business-related constraints, and specific goals may vary from one implementation to another. Development efforts might be complex and time consuming and may involve many aspects of design, fabrication, and manufacture. Nevertheless, it should be appreciated that such development projects would be a routine effort for those of ordinary skill having the benefit of this disclosure.

The terms “upper” and “lower” and “upstream” and “downstream” as used herein to describe components of the novel check valves are relative to the desired flow direction of gas through the valve. In the figures, the flow direction is depicted as left-to-right, whereas the reverse flow direction is right-to-left. Thus, “upper” and “upstream” refers to a location or orientation toward the inlet of the check valve. “Lower” or “downstream” is relative to the outlet of the check valve.

“Axial,” “radial,” “angularly,” and forms thereof reference the primary axis of the novel gas check valves, that is, the central axis extending the length of the valve. For example, axial movement or position refers to movement or position generally along or parallel to the primary axis. “Lateral” movement and the like also generally refer to up and down movement or positions up and down the primary axis. “Radial” will refer to positions or movement toward or away from the primary axis.

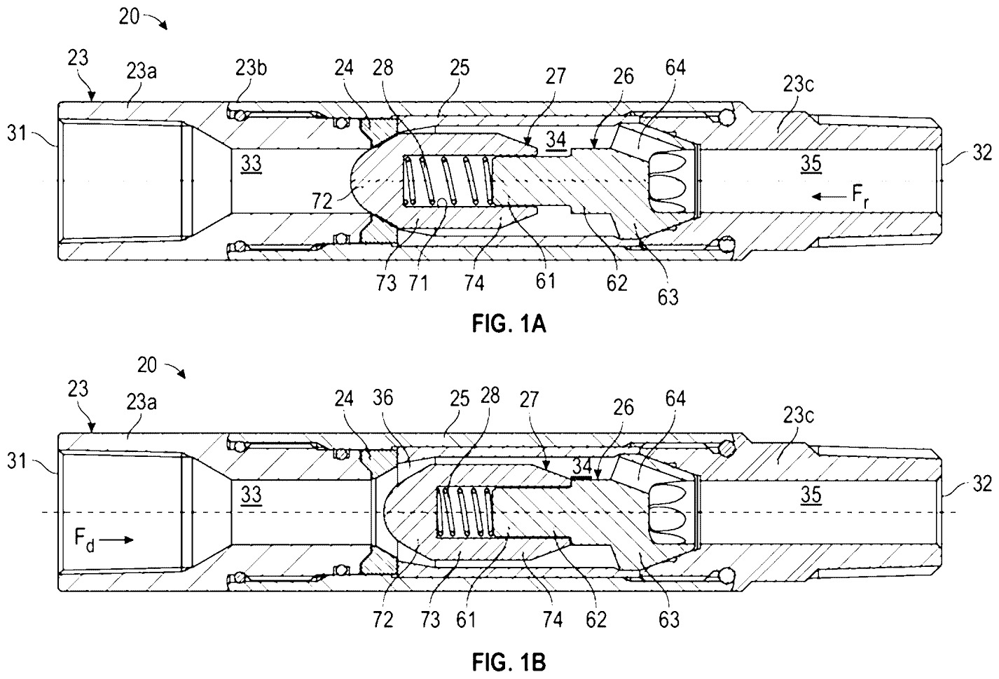

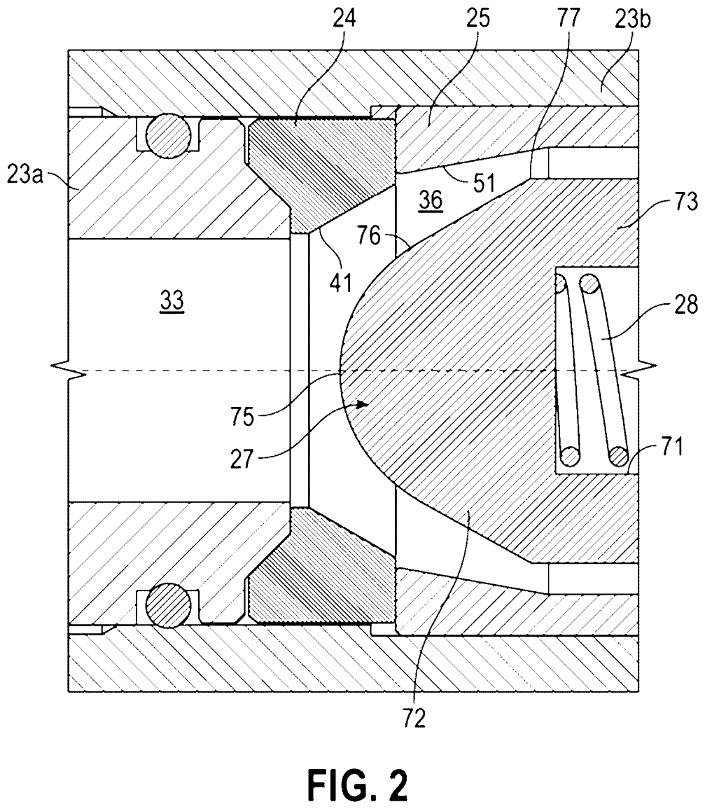

Turning now to several descriptions, with reference to figures, or particular embodiments incorporating one or more aspects of the disclosed inventions, The novel check valves may be assembled into a downhole gas flow line forming part of, for example, a gas lift system that assists in producing liquids from an oil and gas well. Specifically, they may be used to ensure that gas flows only in a desired flow direction through the flow line. A first preferred embodiment 20 of the novel downhole gas check valves is shown in FIGS. 1 and 2. Valve 20 is a gas check valve. As may be seen in FIGS. 1, gas check valve 20 generally comprises a housing 23, a valve seat 24, a wear sleeve 25, a valve stem 26, a dart 27, and a resilient member, such as spring 28. Spring 28 biases dart 26 onto valve seat 24 such that, as described further below, gas can flow through valve 20 in a flow direction F_{d}, but is checked in a reverse flow direction Fᵣ.

Valve housing 23 (the valve housing sometimes being referred to as a valve body) provides the base on and in which the other valve components are assembled. As seen in FIGS. 1, it has a generally open, elongated cylindrical shape. Preferably, as shown therein, housing 23 is assembled from three generally open-cylindrical subs: an upper sub 23a, a middle sub 23b, and a lower sub 23c. Subs 23a/23b/23c are assembled together, for example, by threaded connections. Upper sub 23a and lower sub 23c have connections adapted to allow valve 20 to be assembled into a flow line, for example, by threaded connections at, respectively, an inlet 31 and an outlet 32. Because the inlet 31 is associated with an opening of upper sub 23a, upper sub 23a may at times be referred to herein as an inlet sub. Likewise, because the outlet 32 is associated with an opening of lower sub 23c, lower sub 23c may at times be referred to herein as an outlet sub. Further, because the dart, in the illustrated example, is positioned within middle sub 23b, middle sub 23b may at times be refereed to as a dart sub.

As further shown in the figures valve housing 23, along with valve seat 24, wear sleeve 25, valve stem 26, and dart 27 provide an internal flow path for fluids and/or gas through valve 20 that extends from inlet 31 to outlet 32. It will be understood that the fluids flowing through the exemplary valve can comprise gas, liquids, or gas/liquid mixtures and/or any of the foregoing combined with particulates within the fluid flow. As such, references herein to “liquid,” “gas,” “fluid” shall each be understood to include liquid, gas, and/or fluid (and any particulates contained therein).

The flow path may be visualized as constituting an upper conduit 33 extending axially through upper sub 23a, a middle conduit 34 extending axially from valve seat 24 to the lower end of valve stem 26, and a lower conduit 35 extending axially through lower sub 23c. The cross-sectional area of the flow path, as described further below, varies as it passes through conduits 33/34/35. For convenience, the term “flow area” will be used as shorthand to reference the cross-sectional area through which flow occurs.

Valve seat 24 is an annular body mounted in housing 23 downstream of upper conduit 33. More particularly, it is mounted within middle sub 23b and between the downstream end of upper sub 23a and the upstream end of wear sleeve 25. It is composed preferably from a resilient material, such an elastomer. Valve seat 24 has a seat area 41. Seat area 41 has the geometry of a frustum, that is, the lower portion of an open, right circular cone truncated by a plane parallel to the base of the cone. Such geometry and close approximations thereof are referred to herein a “frustoconical.”

As used herein, an “expanding” fustroconical surface shall refer to a frustoconical surface that has a smaller upstream diameter than its downstream diameter, thus expanding in flow direction F_{d}. In other words, in the example of FIGS. 1A and 1B, the valve seat defines a valve seat expanding opening including a section having an internal cross-sectional diameter that increases axially from a first point along the axis of the valve housing to a second point along the valve housing axis, wherein the first point is closer to the inlet than is the second point.

A “diminishing” frustoconical surface has a larger upstream diameter than its downstream diameter, thus diminishing in in flow direction F_{d}.

Seat area 41 thus provides valve seat 24 with an interior, expanding frustoconical surface allowing flow through valve seat 24 (or, in other words, a valve seat expanding opening including a section having an internal cross-sectional diameter that increases axially from a first point along the axis of the valve housing to a second point along the valve housing axis, wherein the first point is closer to the inlet than is the second point.)

Wear sleeve 25 has a generally open-cylindrical geometry and is mounted in housing 23 downstream of valve seat 24. More particularly, it is mounted within middle sub 23b between valve seat 24 and lower sub 23c. Although the substantial length, that is the lower portion of wear sleeve 25 is cylindrical, it has an expanding frustoconical interior surface 51 at its upper end. Wear sleeve 25 preferably will be fabricated from hard, wear resistant steels, such as tungsten steels or a tungsten carbide material.

In the illustrated example, valve stem 26, which may also be referred to as valve stem member 26, is mounted in housing 23 downstream of wear sleeve 25. More particularly, it is mounted within an enlarged diameter lower end of wear sleeve 25 and an enlarged diameter portion of lower sub 23c. Valve stem 26 may be viewed as having a post 61, a midsection 62, and a base 63. Post 61 forms a cylindrical upper portion of valve stem 26 and has a reduced diameter relative to midsection 62, thus creating an upward facing shoulder. Base 63 of valve stem has a generally enlarged diameter relative to midsection 62. Its upstream face tapers axially downward across its radial extent. A plurality of flow ports 64, for example, five flow ports 64 extend through valve stem base 63 from its upstream face. Flow ports 64 extend axially downward and radially inward until they terminate at the upstream end of lower conduit 36 in lower sub 23c. The geometry of base 63, of the lower end of wear sleeve 25, and the upper end of lower housing sub 23c, however, may vary and will be coordinated as desired to capture valve stem 26 and securely mount it within housing 23.

As appreciated by comparing FIGS. 1A and 1B, a movable valve member, which in the illustrated example takes the form of dart 27 is mounted for axial movement on valve stem 26 between a shut position (sometimes referred to as a closed position) and an open position. In its shut position, dart 27 is seated on valve seat 24 and shuts off flow through valve 20, and in its open position, dart 27 is pushed off valve seat 24 to allow flow through valve seat 24 and valve 20. More particularly, dart 27 has a bottomed stem hole 71 extending axially upward from its lower face that closely accommodates post 61 of valve stem 26. Spring 28 is loaded under compression within stem hole 71 between the bottom of hole 71 and the top of valve stem post 61. Dart 27 thus is biased onto valve seat 24. Spring 28 is selected such that it allows dart 27 to move down and away from valve seat 24 and towards its open position in response to fluid flowing through valve 20 in flow direction Fa. Dart 27 will move toward and seat on valve seat 24 in response to a cessation of flow in flow direction Fa or fluid flowing through valve 20 in reverse flow direction Fr.

Dart 27 may be viewed as having a nose 72, a shaft 73, and a tail 74. Relative to flow through valve 20 in flow direction Fa, nose 72 is the leading surface of dart 27. It has different geometries, as best appreciated from the enlarged view of FIG. 2. A leading surface 75 of dart 27 preferably is a spherical cap, as shown, or an ovoid cap. Spherical cap 75 leads into an expanding frustoconical seating area 76. Seating area 76 is the portion of dart 27 that contacts and seats on seat area 41 of seat 24. It will be appreciated that the angle (relative to the central axis of valve 20) of seating area 76 on dart 27 is somewhat greater than the angle of seat area 41 of valve seat 24. That will allow dart 27 to seat and unseat from valve seat 24 more cleanly and reliably. Seating area 76 may lead directly into shaft 73 of dart 27 as shown, but preferably a transition area 77 of nose 72 is provided with a short, small radiused area that provides a smoother transition from seating area 76 to shaft 73.

Considering the shape of the dart 27 in FIGS. 1A and 1B, the dart 27 may be described as one that includes an intermediate, generally cylindrical outer surface section; and a tail surface including a section having a cross-section that decreases from a seventh point along the axis of the valve housing to an eighth point, wherein the seventh point is closer to the inlet than is the eighth point.

As further reflected in the figures, in the example, the nose 72 can be considered as providing a dart seating surface, where the dart seating surface includes a section having a cross-section that increases axially from a third point along the axis of the valve housing to a fourth point, wherein the third point is closer to the inlet than is the fourth point.

Shaft 73 is generally cylindrical and leads into tail 74 of dart 27. Tail 74 has a diminishing frustoconical outer surface that terminates in a downward facing shoulder. When valve 20 is fully open, dart 27 will bottom out on the upward facing shoulder on midsection 62 of valve stem 26.

Thus, it will be appreciated that flow through valve 20 will be shaped by the internal geometry of valve 20. More specifically, and disregarding turbulence and drag, flow through upper conduit 33 and lower conduit 35 will be generally cylindrical. The respective flow areas are equal to a circle having a diameter equal to that of upper conduit and that of lower conduit 35. Middle conduit 34 is defined by valve seat 24, wear sleeve 25, valve stem 26, and dart 27. Flow through middle conduit 34 will be annular until it divides into separate streams as fluid passes through ports 64 in base 63 of valve stem 26. Specifically, fluid will flow within valve seat 24 and wear sleeve 25 and around valve stem 26 and dart 27.

It will be appreciated that middle conduit 35 provides in general a choke area for fluid flowing through valve 20. That is, dart 27 is sized relative to valve seat 24 and wear sleeve 25 such that the flow area around nose 72 and along shaft 73 of dart 27 is smaller than the flow area through upper conduit 34. Moreover, it will be appreciated that the geometry of valve seat 24, wear sleeve 25, and dart 27, and primarily the geometry of frustoconical surface 51 on wear sleeve 25 and frustoconical seating area 76 of nose 72, creates a variable choke as dart 27 moves between its shut and open positions.

In alternative language, the frustoconical surface 51 on wear sleeve 25 can be considered to form a ring member that has expanding opening including a section having a cross-sectional diameter that increases axially from fifth point along the valve housing axis to a sixth point along the valve housing axis, wherein the fifth point is closer to the inlet than is the sixth point. As will be appreciated from the figures under discussion, in the accompanying embodiment the ring member is integrally formed with the wear sleeve 25.

More specifically, when dart 27 is seated on valve seat 24, the nose-shaft transition area of dart 27 will be positioned axially proximate the upper end of frustoconical surface 51 on wear sleeve 25. The clearance between the nose-shaft transition area of dart 27 will be at a minimum When dart 27 is in it fully opened position and bottomed out on midsection 62 of valve stem 26, the nose-shaft transition area of dart 27 will be within, but axially proximate the lower end of frustoconical surface 51 on wear sleeve 25. Thus, as dart 27 moves from its shut position toward its fully open position, the flow area between wear sleeve 25 and dart 27 will gradually increase, thus decreasing the choke. Conversely, as dart 27 moves from its open position to its shut position, the flow area will decrease and increase the choke. Preferably, wear sleeve 25 and dart 27 are dimensioned such that the maximum flow area and minimum choke provided when dart 27 is bottomed out in its fully open position is significantly less, preferably approximately 25% less than the flow area in upper conduit 33.

After passing through the variable choke area in the upper portion of middle conduit 34, the flow area enlarges as it passes around tail 74 of dart 27 and midsection 62 of valve stem 26. The flow area though this portion of middle conduit 34 preferably will be significantly larger than the flow area of upper conduit 33, such as about 70% larger. The flow area through ports 64 in valve stem 26 will be approximately equal or somewhat less than the flow area through upper conduit 33, as will be the flow area through lower conduit 35.

Thus, flow through middle conduit 34 of valve 20 will create an area of high pressure across nose 72 of dart 27 and an area of low pressure behind dart 27 that will tend to maintain dart 27 in its bottomed out, fully open position as fluid flows through valve 20. Conversely, the variable choke area provided around nose 72 of dart 27 will dampen the effects of variable back pressure in the gas line.

An alternative way to consider the flow path of the illustrated embodiment is one where when the dart is in its open position, the flow area through the valve transitions along an internal axial flow path from the valve inlet to the valve outlet:
(a) from a first flow area to a second flow area, wherein the first flow area is within the inlet sub and the second flow area is within the valve seat expanding opening, and wherein the second flow area is greater than the first flow area;
(b) from the second flow area to a third flow area, wherein the third flow area is within the ring member expanding opening, and wherein the third flow area is greater than the second flow area;
(c) from the third flow area to a fourth flow area, wherein the fourth flow area is partially defined by a surface of the dart, and wherein the fourth flow area is less than the first, second, and third flow areas; and
(d) from the fourth flow area to a fifth flow area, wherein the fifth flow area is partially defined by a surface of the dart, and wherein the fifth flow area is greater than the second flow area.

Additional aspects of the exemplary embodiment may be considered from a more detailed consideration of FIG. 2. Referring to FIG. 2, it will be appreciated that the conduit of the inlet sub 23a defines a bore passing axially through the input sub 23a and that the bore 33 has a cross-sectional diameter. It will also be appreciated from the figure that the input sub 23a further includes an end surface that abuts the valve seat 24. In the example, valve seat is formed from a resilient material and is held between the end surface of the inlet sub and another surface, which in the example of FIG. 2 is an end surface of wear sleeve 25. As previously describe, in the embodiment of FIG. 2, the valve seat defines a valve seat expanding opening including a section having an internal cross-sectional diameter that increases axially from a first point along the axis of the valve housing to a second point along the valve housing axis, wherein the first point is closer to the inlet than is the second point.

As shown in FIG. 2, in the illustrated example, when the dart is in its open position, the smallest cross-sectional diameter of the valve seat expanding opening is less than the smallest cross sectional diameter of the inlet sub 23a. This is significant because this geometry results in a portion of the input sub 23a extending into the interior flow path at point at the downstream side of the valve seat 24, to greater extent than the valve seat 24 extends into the flow path. This greater extension, forms a protective structure that tends to both: (i) protect the valve seat from being degraded by abrasive materials in the flowing fluid (by providing a physical barrier preventing impingement of abrasive materials on the valve seat 24) and (ii) create a fluid flow path through the valve wherein abrasive continuing fluids tend to flow way from (or across) at least a portion of the valve seat sealing surface, thus tending to prolong the useful life of the valve seat.

As will be appreciated, the embodiment discussed above in connection with FIGS. 1A and 1B, is but one example of a check valve that may be constructed in accordance with the teachings of this disclosure. Many variant embodiments will be apparent to those of ordinary art having the benefit of this disclosure.

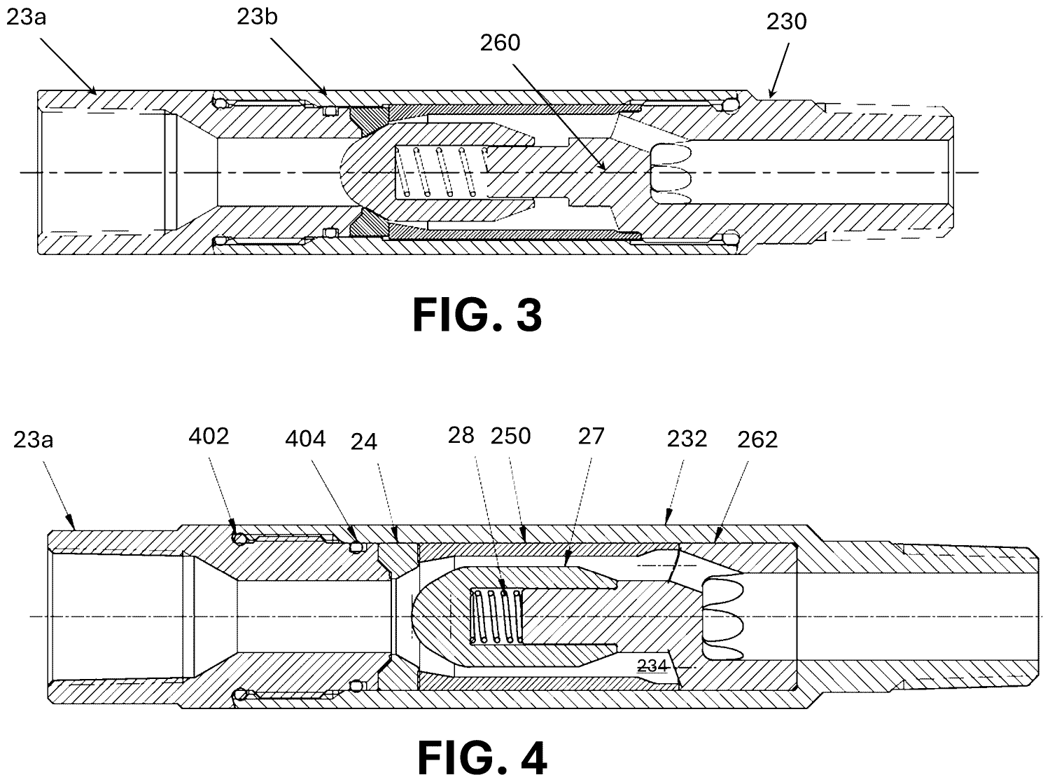

For example, in the exemplary embodiments of FIGS. 1A and 1B, the valve stem member 26 is formed separately of the various housings that comprise the valve housing. Alternate embodiments are envisioned wherein the valve stem member 26 is integrally formed with one of the sub-housings. FIG. 3 illustrates one such exemplary embodiment wherein the valve body comprises an inlet sub 23a, a middle sub 23b and an alternate designed output sub 230c and wherein the outlet sub 230c includes an integrally formed valve stem member 260.

As an other example of an alternate embodiment that is within the teachings of the present disclosure, the valve body need not be formed from three sub housings as was discussed above in connection with FIGS. 1A and 1B. Alternate embodiments are envisioned in which the valve body comprises only two sub-housings. One example of such an alternate embodiment is illustrated in FIG. 4, where the valve body is formed from an input housing 23a and an outlet housing 232. Note that FIG. 4 also illustrates an alternate construction for the wear sleeve 25 of FIGS. 1A and 1B. Specifically, in the example of FIG. 4, an alternate wear sleeve 262 is illustrated that includes an interior surface that defines an expanded flow area in region 234.

It will also be noted that FIG. 4 illustrate an alternate design for valve stem member 26, in that FIG. 4 depicts a valve stem member 262 that has generally flat surface roughly perpendicular to the axial flow path through the valve that abuts a generally flat surface of the outlet housing 232 that is also generally perpendicular to the axial flow path through the valve.

It will also be appreciated that FIG. 4 illustrates the use of O-rings 402 and 404 to seal the connection between the inlet housing 23a and the outlet housing 232. Such O-rings can be used the other disclosed embodiments to facilitate a sealing engagement between various components of the valve housing.

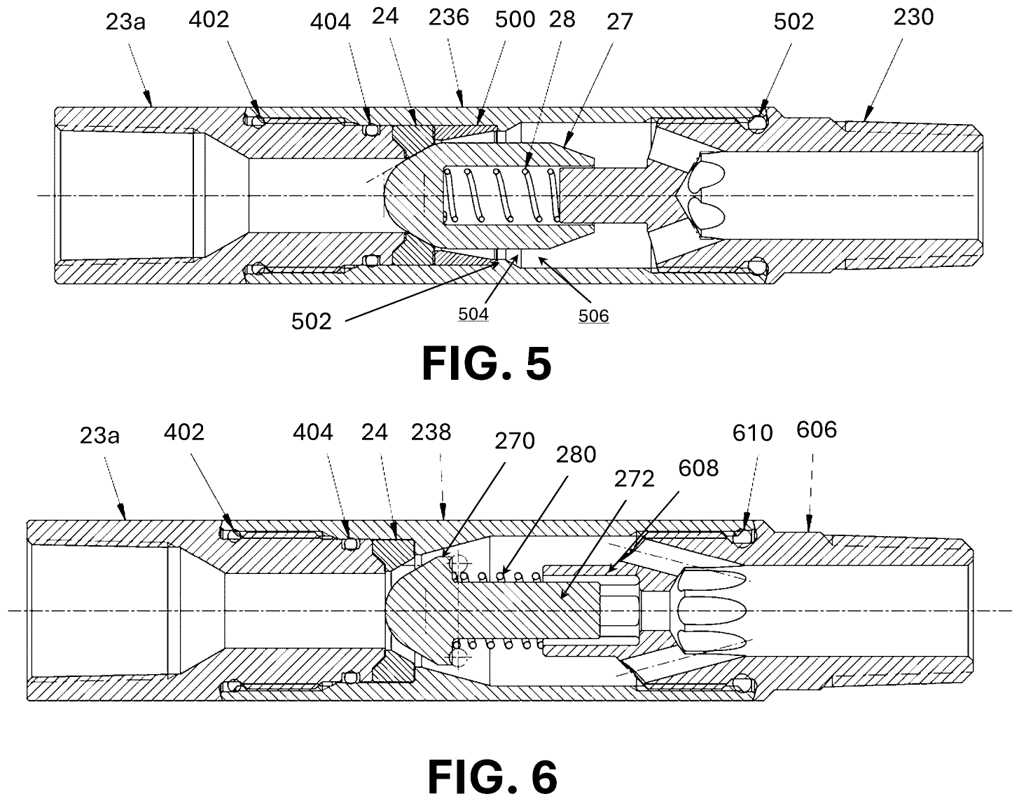

As a further example of an alternate embodiment, embodiments are envisioned that do not include a wear sleeve, like wear sleeve 25 in FIGS. 1A and 1B. FIG. 5 illustrates one such embodiment.

Referring to FIG. 5, an alternate embodiment check valve is illustrated that includes a valve housing formed by an input sub-assembly 23a, an output sub-assembly 230 (including an integrally formed valve stem portion) and a middle (or dart) sub-assembly 236. In the exemplary embodiment of FIG. 5, the dart sub assembly 236 defines an internal annular edge surface 502. A wear ring 500 that includes a first end surface that abuts the annular edge surface of the dart sub and a second end surface. The wear ring defines an expanding opening having a cross-sectional diameter that increases axially from a first point along the second housing bore axis to second point along the second housing bore axis, wherein the first point is closer to the valve inlet than is the second point.

In the illustrated example of FIG. 5, the valve seat 24 is held between an end surface of the input sub 23a and the second end surface wear ring 500.

As further reflected in the figure, in the embodiment of FIG. 5, the valve includes an interior surface profile, defined by an interior surface of the valve housing (in the example, an internal surface of dart sub 236) that is that includes an expanding opening section 504 having a cross-sectional diameter that increases axially from a first point along the second housing bore axis to second point along the second housing bore axis, wherein the first point is closer to the valve inlet than is the second point; and an internal cylindrical bore section 506, wherein the internal cylindrical bore section has having a generally consistent internal diameter.

The use of the dart and spring configuration discussed with respect to the previous example embodiments is not essential to all embodiments of the present disclosure and alternate embodiments are possible. For example, FIG. 6 illustrates an example where an alternate dart structure is utilized.

FIG. 6 illustrates an exemplary valve that, like the exemplary valve of FIG. 5, includes a three-art valve body, with the valve body in FIG. 6 being formed from an inlet sub 23, a dart sub 238 and an outlet sub 606. In the exemplary figure, the outlet sub 606 defines a valve post receiving area 608 that, in the example includes slot like openings.

In the example of FIG. 6, a dart 270 is located within the dart sub 238. The illustrated dart 270 includes a seating surface (on the left side of dart 270 in FIG. 6) and a dart post 272, wherein the dart post extends from the dart at a location further from the inlet than is the dart seating surface. In the example, the dart post 272 extends into the post receiving area 60. A spring 280 at least partially surrounds the dart post 272 and serves to bias the dart 270 in its closed position.

FIG. 6 also illustrates an example where the valve seat 24 is positioned between an edge of the input sub 23a and an interior ledge surface of the dart sub 238. Still further, FIG. 6 illustrates an example where the interior surface profile of the valve, which at least partially defines the flow path through the valve, does not comprise the surface or a wear sleeve or separate ring structure, but is rather formed from the interior profiles of the subs forming the housing. In the illustrated example the dart housing 238 forms at least part of this interior surface profile and includes a portion that defines an expanding opening surface (beginning in the area of the dart seating surface) and a generally cylindrical surface (in the area of the dart post and the valve post receiving area).

While the various exemplary embodiments have been disclosed and discussed primarily in terms of specific embodiments thereof, they are not intended to be limited thereto. Other modifications and embodiments will be apparent to the worker in the art and other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa. Similarly, elements have been described functionally and can be embodied as separate components or can be combined into components having multiple functions.

Further, while the inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

What is claimed is:

1. A downhole check valve for controlling flow of gas through a flowline of a gas lift system, the downhole check valve comprising:
(a) a valve housing having an inlet, an outlet, and an internal flow path extending from the inlet to the outlet, the valve housing comprising:
i) a dart sub, the dart sub having a bore passing axially therethrough;
ii) an inlet sub coupled the dart sub, the inlet sub having a bore passing axially therethrough and an end surface, the inlet sub bore having at least one cross-sectional diameter;
(b) a valve seat located within the valve housing, the valve seat being formed from a resilient material and held between the first end surface of the inlet sub and another surface, the valve seat defining a valve seat expanding opening including a section having an internal cross-sectional diameter that increases axially from a first point along the axis of the valve housing to a second point along the valve housing axis, wherein the first point is closer to the inlet than is the second point;
(c) a dart located within valve housing, the dart including:
i) a dart seating surface, the dart seating surface including a section having a cross-section that increases axially from a third point along the axis of the valve housing to a fourth point, wherein the third point is closer to the inlet than is the fourth point;
wherein, the dart is movable between an open position permitting fluid flow through the valve housing and a closed position blocking fluid flow through the valve, and
wherein, when the dart is in its open position, the smallest cross-sectional diameter of the valve seat expanding opening is less than the smallest cross sectional diameter of the inlet sub.

2. The downhole check valve of claim 1 further comprising a ring member positioned within the dart sub, the ring member having an end surface;
wherein the valve seat is held between the end surface of the inlet sub and the end surface of the ring member, and
wherein ring member defines a ring member expanding opening including a section having a cross-sectional diameter that increases axially from fifth point along the valve housing axis to a sixth point along the valve housing axis, wherein the fifth point is closer to the inlet than is the sixth point.

3. The downhole check valve of claim 1 wherein, the dart further comprises a dart post, wherein the dart post extends from the dart at a location further from the inlet than is the dart seating surface, and wherein the check valve further comprises a spring at least partially surrounding the dart post.

4. The downhole check valve of claim 1 wherein, when the dart is in its open position, the flow area through the valve transitions along the axial flow path from the valve inlet to the valve outlet:
(a) from a first flow area to a second flow area, wherein the first flow area is within the inlet sub and the second annular flow area is within the valve seat expanding opening, and wherein the second flow area is greater than the first flow area;
(b) from the second flow area to a third flow area, wherein the third flow area is within the ring member expanding opening, and wherein the third flow area is greater than the second flow area;
(c) from the third flow area to a fourth flow area, wherein the fourth flow area is partially defined by a surface of the dart, and wherein the fourth flow area is less than the first, second, and third flow areas; and
(d) from the fourth flow area to a fifth flow area, wherein the fifth flow area is partially defined by a surface of the dart, and wherein the fifth flow area is greater than the second flow area.

5. The downhole check valve of claim 1 wherein the dart further comprises:
(a) an intermediate, generally cylindrical outer surface section; and
(b) a tail surface including a section having a cross-section that decreases from a seventh point along the axis of the valve housing to an eighth point, wherein the seventh point is closer to the inlet than is the eighth point.

6. The downhole check valve of claim 5 further including a sleeve element, the sleeve element being positioned within the dart sub, and the sleeve element having an internal cylindrical bore section having a generally consistent internal diameter; wherein, when the dart is in its open position, the intermediate, generally cylindrical outer surface section of the dart is located within the sleeve internal cylindrical bore section.

7. The downhole check valve of claim 6 wherein the sleeve element further comprises an expanded section having an expanded internal bore, wherein:
the internal cylindrical bore section is located closer to the valve input than is the expanded section; and
the cross sectional diameter of internal bore expanded section is greater than the cross sectional diameter of the internal cylindrical bore section.

8. The downhole check valve of claim 7 wherein the sleeve element and the ring element are integrally formed.

9. A downhole check valve for controlling flow of gas through a flowline of a gas lift system, the downhole check valve comprising:
(a) a valve housing having an inlet, an outlet, and fluid flow path extending from the inlet to the outlet, the valve housing comprising:
i) a first housing, the first housing having a bore passing axially therethrough and an end surface, the first housing end surface having an opening with a first cross-sectional diameter;
ii) a second housing, the second housing having a bore passing axially therethrough forming part of the fluid flow path through the valve, the second housing being coupled to the first housing;
(b) a valve seat located within the second housing, the valve seat being formed from a resilient material, the valve seat defining a valve seat expanding opening including a section having a cross-sectional diameter that increases axially from a first point along the axis of the valve housing to a second point along the valve housing axis, wherein the first point is closer to the inlet than is the second point;
(c) a surface profile located within the second housing, the surface profile comprising:
i) an end surface, wherein the valve seat is held between the end surface of the first housing and the end surface of the surface profile;
ii) an expanding opening having a cross-sectional diameter that increases axially from a first point along the second housing bore axis to second point along the second housing bore axis, wherein the first point is closer to the valve inlet than is the second point;
iii) an internal cylindrical bore section, wherein the internal cylindrical bore section has having a generally consistent internal diameter;
(d) a movable valve member located within second housing, the movable valve member including:
i) a valve seating surface;
ii) an intermediate, generally cylindrical outer surface section; and
iii) a tail surface including a section having a cross-section that decreases axially from a first point along the axis of the valve housing to a second point, wherein the first point is closer to the inlet than is the second point; and wherein the movable valve member may be oriented in an open position permitting fluid flow through the valve and wherein, when the movable valve member is in the open position, the smallest cross-sectional diameter of the valve seat opening is less than the cross sectional diameter of the second housing opening.

10. The downhole check valve of claim 9 wherein the surface profile further comprises an expanded section having an expanded internal bore, wherein the internal cylindrical bore section is located closer to the valve input than is the expanded section, and the cross sectional diameter of the expanded internal bore is greater than the cross sectional diameter of the internal cylindrical bore section;

11. The downhole check valve of claim 9 wherein both the end surface of the surface profile and the expanding opening of the surface profile comprise surfaces of the second housing.

12. The downhole check valve of claim 9 wherein the check valve further comprises a ring member positioned within the second housing and wherein:
the ring member includes an end surface, the end surface of the surface profile comprises the end surface of the ring member and the valve seat is held between a surface of the first housing and the end surface of the ring member, and
the ring member includes an expanding opening, and the expanding opening of the surface profile comprises the expanding opening of the ring member; and
the internal cylindrical bore section of the surface profile comprises an interior surface of the second housing.

13. The downhole check valve of claim 9 further comprising a sleeve member positioned within the second housing and wherein:
the sleeve member includes an end surface, the end surface of the sleeve member comprises the end surface of the ring member, and the valve seat is held between a surface of the first housing and the end surface of the sleeve member,
the sleeve member includes an expanding opening, and the expanding opening of the surface profile comprises the expanding opening of the sleeve member; and
the internal cylindrical bore section of the surface profile comprises an interior surface of the sleeve member.

14. The downhole check valve of claim 9 further comprising a third housing coupled to the second housing, wherein the third housing defines the valve outlet.

15. The downhole check valve of claim 9 wherein the movable valve member further comprises:
an internal cavity having a closed end, and an open end; and
a resilient member positioned entirely within the internal cavity and between the internal cavity open and closed ends.

16. A downhole check valve for controlling flow of gas through a flowline of a gas lift system, the downhole check valve comprising:
a. a valve housing having an inlet, an outlet, and an internal fluid flow path extending from the inlet to the outlet, the valve housing comprising an inlet housing, the inlet housing defining a first opening comprising the valve housing inlet and second opening, the second opening being located at an end of the inlet housing opposite the first opening;
b. a valve seat located within the valve housing, the valve seat being formed from a resilient material, the valve seat defining a valve seat expanding opening including a section having a cross-sectional diameter that increases axially from a first point along the axis of the valve housing to a second point along the valve housing axis, wherein the first point is closer to the inlet than is the second point;
c. a dart located within valve housing, the dart including:
i. a dart seating surface having a cross-section that increases axially from a third point along the axis of the valve housing to a fourth point, wherein the third point is closer to the inlet than is the fourth point;
ii. an internal cylindrical cavity having a closed end, a closed end surface, an open end, and an open end ledge surface;
d. a valve stem member at least partially positioned within the second housing, the valve stem member including a post that extends into the dart internal cylindrical cavity, the valve stem member further including a ledge surface, and
e. a resilient member positioned entirely within the dart internal cylindrical cavity and between the dart closed end surface and a surface of the post;
wherein, when the downhole check valve is in its open position, the smallest cross-sectional diameter of the valve seat opening is less than the cross sectional diameter of the inlet housing second opening and the dart open end ledge surface at least substantially abuts the ledge surface of the valve stem member.

17. The downhole check valve of clam 16 wherein the valve housing further comprises a dart sub coupled the inlet housing, the dart sub having a bore passing axially therethrough, and wherein the dart is located within the dart sub in its open position.

18. The downhole check valve of claim 17 wherein the valve housing further comprises an outlet sub coupled to the dart sub.

19. The downhole valve of claim 18 wherein the valve stem member includes a plurality of ports permitting fluid flow therethrough and wherein the valve stem member is formed separate from the dart sub.

20. The downhole check valve of claim 16 wherein the valve housing further comprises a dart sub coupled the inlet housing and an outlet housing coupled to the dart sub, wherein the valve stem member includes a plurality of ports permitting fluid flow therethrough, and wherein the valve stem member is integrally formed with the outlet housing.
